(19) United States
(12) Patent Application Publication
(10) Pub. No.: US 2002/0168561 A1
(43) Pub. Date: Nov. 14, 2002

(54) Electrochemical cell stack

(75) Inventors: Gustav Boehm, Uberlingen (DE); Mario Sondermann, Goettingen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/114,596

(22) Filed: Apr. 2, 2002

(30) Foreign Application Priority Data
Apr. 7, 2001 (DE) DE 101 17 572.8

(51) Int. Cl. H01M 8/02; H01M 8/24; H01M 8/10

(52) U.S. Cl. 429/38; 29/623.1; 429/32; 429/39

(57) ABSTRACT

An electrochemical cell stack has alternately arranged membrane electrode assemblies (12) and separator plates (11) having channel regions (13) via which the reactant or oxidant fluids are supplied to and removed from the membrane electrode assembly (12), the separator plates (11), on one side, having a surface structure of channels (15) and ridges (14) located therebetween and, on the other side, having a surface structure which is negative with respect thereto. According to the present invention, the separator plates (11) include a channel region (13) which is offset from the geometric center (M) in such a manner that, upon stacking the separator plates (11), with neighboring separator plates (11) being in each case arranged such that they are rotated relative to each other by 180° about the surface normal (F), the separator plates (11) lie over each other in such a manner that forces acting from outside are transmitted without any flexural moment with respect to the MEA (12) located between the separators plates (11).

Priority to German Application No. 101 17 572.8 filed Apr. 7, 2001 and incorporated-by-reference herein is hereby claimed.

### BACKGROUND INFORMATION

The present invention relates to an electrochemical cell stack, in particular, a PEM or DMFC fuel cell stack.

Electrolytic cells are electrochemical assemblies which produce chemical substances such as water and oxygen at catalytic surfaces of electrodes while electric energy is being supplied. Fuel cells are electrochemical assemblies which produce electric energy by conversion of chemical energy at catalytic surfaces of electrodes.

Electrochemical cells of this kind include the following main components:

a cathode electrode at which the reduction reaction takes place through the addition of electrons. The cathode includes at least one electrode substrate layer which serves as a carrier for the catalyst.

an anode electrode at which the oxidation reaction takes place through the release of electrons. The anode, just as the cathode, is constituted by at least one substrate layer and catalyst layer.

a matrix which is arranged between the cathode and the anode and serves as a carrier for the electrolyte. The electrolyte can exist in a solid or liquid phase or as a gel.

Advantageously, the electrolyte is bound within a matrix in a solid phase, forming a so-called “solid electrolyte”.

These three components specified above are also referred to as membrane-electrode assembly (MEA), the cathode electrode being applied on one side of the matrix and the anode electrode being applied on the other side.

a separator plate which is arranged between the MEA's and serves to collect the reactant and oxidant in the electrochemical cells.

sealing elements which prevent both mixing of the fluids in the electrochemical cells and escape of the fluids from the cell to the surroundings.

When stacking electrolytic cells or fuel cells one over another, then an electrolysis stack or fuel cell stack results which will hereinafter also be referred to as a stack. In this context, the current is routed from cell to cell in a series circuit. The fluid management of the oxidant and reactant is carried out via collecting and distributing channels to the individual cells. In electrochemical cells, the cells of a stack are supplied with the reactant and oxidant fluids, for example, in parallel via at least one distributing channel for each fluid, respectively. The reaction products as well as excess reactant and oxidant fluids are led out of the cells and of the stack via at least one collecting channel, respectively.

In order for electrolysis cells or fuel cells to be used in an economical manner for mobile applications, it is required to achieve the production costs of internal combustion engines for comparable ratings. Since, for operating mobile systems having electric motors, cell stacks containing a multitude of cells (>300 pieces) are needed, it is important that the cell components be of low cost per piece. The piece cost includes both material and manufacturing costs.

Moreover, there is a demand for fuel cells having a thin cell thickness. In this connection, one usually uses thin membrane electrode assemblies. These MEA's are very flexible and, beyond a certain mechanical load as occurs during the stacking of separator plates, may be destroyed. The stacking of identical separator plates with MEA's located therebetween has the effect that the ridges and channels of the separator plates lie one over the other, respectively, thus falling into one another. In this case, one speaks of an egg box effect. Then, the MEA located therebetween can be damaged or destroyed because of its flexibility. Moreover, the flow through the channel is hindered or prevented. The problem of the egg box effect occurs, in particular, when the stacked separator plates are pressed together. By pressing the plates together, on one hand, an improved electrical contact between the plates is produced and, on the other hand, a sealing of the plates is achieved.

In the non-prepublished German Patent Document DE 100 47 248, the egg-box effect is prevented by using two different separator plates with the MEA being arranged therebetween. In this connection, the separator plates are designed in such a manner that, upon stacking, a channel of one plate lies over a ridge of the other plate. Neighboring separator plates are supported in this manner, preventing the MEA from being destroyed. In this context, it is a disadvantage that the production costs of the cell stack are increased because two different separator plates are manufactured.

U.S. Pat. No. 6,040,076 discloses a fuel cell stack which is formed by stacking identical separator plates, i.e., only one type of separators plates is used. By embossing a flat plate, these separator plates have a surface structure for distributing the oxidant on one side and, on the other side, feature a surface structure which is negative with respect thereto and used for distributing the reactant. Upon stacking the separator plates, the MEA is arranged between the separator plates, the MEA constituting a mechanically stable assembly. Due to this very stable construction of the MEA, it is not possible for the so-called “egg box effect” to have any effect. However, the large cell thickness of the fuel cells due to the relatively large thickness of the MEA's is a disadvantage.

In comparison, MEA's on the basis of polymer electrolyte membranes (PEM) are very thin and flexible. The present stage of development shows that there is a demand for MEA's of even smaller thickness on the order less than 0.5 mm.

### SUMMARY OF THE INVENTION

An object of the present invention is to provide a fuel cell stack which is composed of identical separator plates, and in which, when using thin MEA's, the MEA'are prevented from being destroyed due to the egg box effect.

The present invention provides an electrochemical cell stack comprising alternately arranged membrane electrode assemblies and separator plates having channel regions via which the reactant or oxidant fluids are supplied to and removed from the membrane electrode assembly. The separator plates, on one side, have a surface structure of channels and ridges located therebetween and, on the other side, have a surface structure which is negative with respect thereto. The separator plates (11) include a channel region (13) which is offset from the geometric center (M) in such a manner that, upon stacking the separator plates (11), with neighboring separator plates (11) being in each case arranged such that they are rotated relative to each other by 180° about the surface normal (F), the separator plates (11) lie over each other in such a manner that forces acting from outside are transmitted without any flexural moment with respect to the MEA (12) located between the separators plates (11).

According to the present invention, the separator plates include a channel region which is offset from the geometric center in such a manner that, upon stacking the separator plates, with neighboring separator plates being in each case arranged such that they are rotated relative to each other by 180° about the surface normal, the separator plates lie over each other in such a manner that forces acting from outside are transmitted without any flexural moment with respect to the MEA located between the separators plates.

Thus, the separator plates have no centrally formed channel region but a channel region which is arranged asymmetrically with respect to the geometric center. If now, a separator plate according to the present invention and a separator plate which is rotated by 180° about the plate normal are arranged one above the other, then these will not fall into one another but mutually support each other, whereby damage to the MEA located therebetween due to the egg box effect or because of heavy shearing stresses on the MEA is prevented. Moreover, malfunctions because of channels which are narrowed by deflections of the MEA are avoided. In this context, this support or direct support is achieved in that, upon stacking the plates, the channels of one plate and the ridges of the neighboring plate lie one over the other. In this manner, destruction of the MEA or an impairment of the fluid flow upon stacking the separator plates is prevented.

In this connection, it should be remarked that, way of looking at the separator plate, a deflection in the plate can be regarded as a channel or as a ridge. In the following, the negative deflections from the top side of the separator plate will be referred to as channels and the positive deflections will be referred to as ridges. Consequently, the superposition of channels of one plate and ridges of the other plate means that these plates mutually support each other, which prevents the plates from falling into one another.

It is an advantage of the present invention that only identical separator plates are used for manufacturing the fuel cell stack, permitting a reduction of the production cost. A further advantage is that the other parts of the separator plates remain unchanged, such as the openings for the ports which serve for supplying and removing the reactant and oxidant fluids of the separator plate, the distribution regions for influencing the fluid distribution from the port regions to the channel regions, as well as sealing regions.

In an advantageous embodiment of the present invention, the channel region is offset perpendicular to at least one channel direction, the distance by which the channel region is offset corresponding to half the distance from the channel center to the ridge center or to a whole-number multiple thereof. Through the arrangement according to the present invention of the separator plates, the ridges of one plate and the channels of the neighboring plate thus lie one over the other. In this manner, the MEA is prevented from being damaged. It is, of course, also possible for the offset distance of the channel region to be selected in such a manner that, upon stacking the separator plates, the ridges of one plate and the channels of the neighboring plate lie just over one another.

An exemplary channel region having a parallel channel structure features channels having only one direction. In the separator plate according to the present invention, the channel region is offset by a corresponding distance perpendicular to this direction. In the case of a channel region having a meander-shaped channel structure, however, there exist at least two channel directions, i.e., the channels have bends. In this case, the channel region of the separator plate according to the present invention is offset perpendicular to each channel direction by a corresponding distance. This distance is preferably just half the distance from the channel center to the ridge center or a whole-number multiple thereof.

In a further preferred embodiment of the present invention, the channels and the ridges of the channel region have different cross-sections. In this manner, the reactant fluid flowing on one side of the separator plate and the oxidant fluid flowing on the other side can be optimally rated to get optimum power from the electrochemical cell. This rating is necessary, because different volume flows are required for the reactant and oxidant fluids.

Thus, the fuel cell stack according to the present invention allows neighboring separator plates to be supported given an arbitrary surface structure of the channel region so that the MEA's located therebetween are not destroyed. Moreover, it is achieved through the inventive stacking of the separator plates that the fluidic conditions of the reactant and oxidant fluids are the same in each cell, ensuring uniform cell performance in the stack.

### BRIEF DESCRIPTION OF THE DRAWINGS

The present invention and further advantageous embodiments of the present invention will be explained in greater detail with reference to drawings.

FIG. 1 is a sectional view of a fuel cell stack having identical separator plates according to the related art;

FIG. 2 is a sectional view of another fuel cell stack according to the related art, featuring two different separator plates;

FIG. 3 shows a fuel cell stack according to the present invention, featuring identical separator plates having a channel region which is offset from the geometric center.

### DETAILED DESCRIPTION

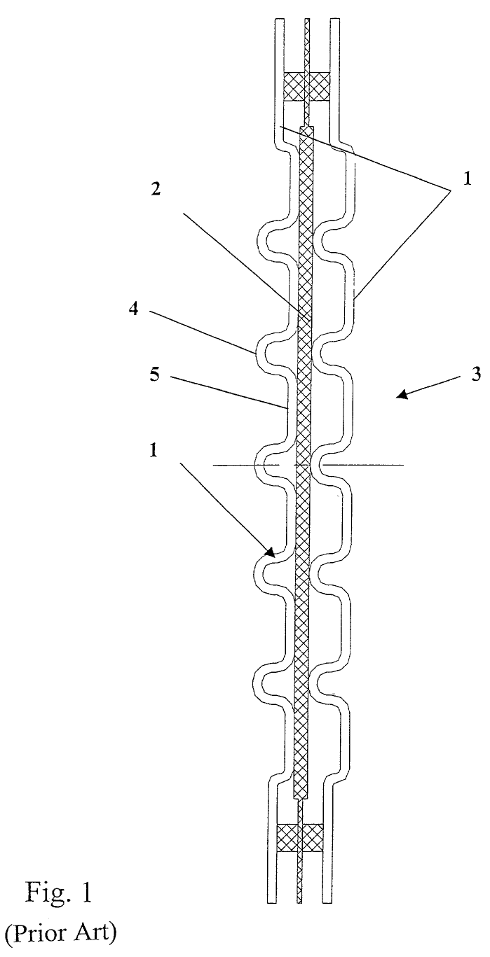

FIG. 1 is a sectional view of a fuel cell stack having identical separator plates according to the related art. An MEA 2 is arranged between the two identical separator plates 1. In this context, separator plate 1 includes a channel region 3 featuring ridges 4 and channels 5. In the fuel cell stack, stacked separator plates 1 lie over one another in such a manner that ridges 4 and channels 5 of separator plates 1 each lie one over the other, thus falling into one another. Therefore, the MEA located therebetween is subjected to high shearing stress. Moreover, the deflection of the MEA gives rise to a narrowing of the channel cross-section.

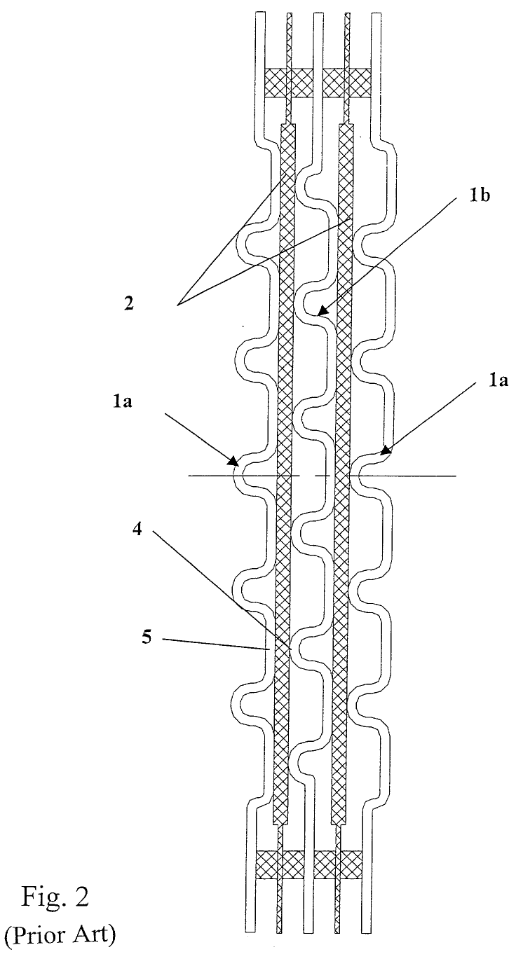

FIG. 2 depicts another fuel cell stack according to the related art. Here, two different separator plates 1a, 1b are used. In this context, separator plates 1a, 1b are designed in such a manner that, upon stacking, a channel 5 of plate 1b and a ridge 4 of neighboring plate 1a lie one over the other. Because of this, MEA 2 located therebetween is loaded in a force-locking manner. No flexural moments occur in MEA 2, as a result of which damage is prevented.

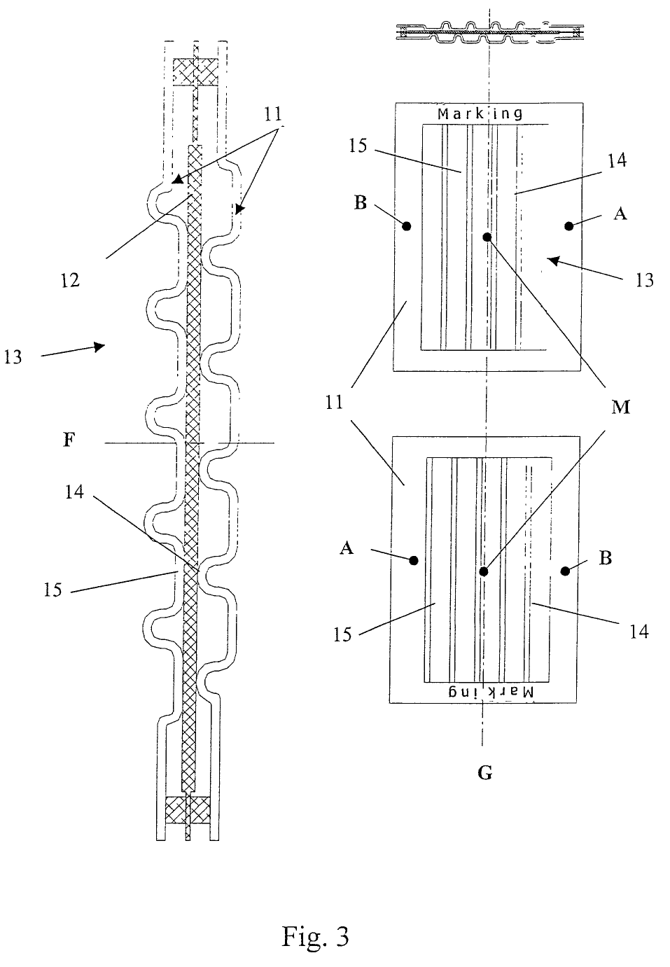

FIG. 3, in the representation on the left, shows a lateral view of a fuel cell stack of the present invention having identical separator plates. Channel region 13 of separator plates 11 advantageously includes an identical number of ridges 14 and channels 15. The two neighboring separator plates 11 are identical and arranged in such a manner that they are rotated relative to each other by 180° about surface normal F of separator plate 11. Moreover, channel region 13 of separator plates 11 is offset from geometric center M (representations on the right). In this context, separator plates 11, which are arranged one over another with an MEA 12 located therebetween, mutually support each other, with a channel 15 of the one plate 11 and a ridge 14 of neighboring plate 1 lying one over the other. Not shown are the openings for the ports for supplying and removing the fluids and the distribution regions for distributing the fluids into the channel region.

In the upper right representation in FIG. 3, an exemplary separator plate featuring a parallel channel structure is shown in a top view. The upper representation shows a separator plate 11 featuring a channel region 13 which is offset from geometric center M of plate 11. In this connection, the offset is accomplished in a direction perpendicular to the channel direction, the offset length corresponding to half the distance between the channel center and the ridge center. As a result of this, right border A and left border B of separator plate 11 have different widths.

The bottom right representation shows the same separator plate 11 rotated by 180° about surface normal F. In this context, in separator plate 11, left border B of the lower representation now corresponds to right border A from the upper representation, and right border A of the lower representation corresponds to left border B of the upper representation. Broken line G indicates geometric center M which is projected onto the surface of separator plate 11. It is recognizable from the two representations that, by rotating separator plate 11 (lower representation), channels 15 and ridges 14 of the stacked separator plates do not lie one over another and thus, do not fall into one another.

What is claimed is:

1. An electrochemical cell stack comprising:
at least one membrane electrode assembly;
a first separator plate on one side of the membrane electrode assembly and a second separator plate on another side of the membrane electrode assembly, the first and second separator plates having channel regions for reactant or oxidant fluids for the membrane electrode assembly, the channel regions including channels and ridges and being offset from a geometric center, the first separator plate having a similar channel region as the second separator plate,
the first separator plate being arranged so as to be rotated relative to the second separator plate by 180° about a surface normal, the first and second separator plates lying over each other in such a manner that forces acting from outside are transmitted without any flexural moment with respect to the membrane electrode assembly located between the first and second separators plates.

2. The cell stack as recited in claim 1 wherein the channel region is offset perpendicular to at least one channel direction, a distance by which the channel region is offset corresponding to half the distance from the channel center to the ridge center or to a whole-number multiple thereof.

3. The cell stack as recited in claim 1 wherein the channel region has an identical number of the channels and the ridges.

4. The cell stack as recited in claim 1 wherein a cross-section of the channels and a cross-section of the ridges are different.

5. A method for manufacturing an electrochemical cell stack comprising:
providing at least one membrane electrode assembly;
providing a first separator plate on one side of the membrane electrode assembly;
rotating a second separator plate so that the second separator plate is arranged relative to the first separator plate by 180° about a surface normal; and
providing the second separator plate on another side of the membrane electrode assembly, the first and second separator plates having channel regions for reactant or oxidant fluids for the membrane electrode assembly, the channel regions including channels and ridges and being offset from a geometric center, the first and second separator plates lying over each other in such a manner that forces acting from outside are transmitted without any flexural moment with respect to the membrane electrode assembly located between the first and second separators plates.
